(19) United States
(12) Patent Application Publication
(10) Pub. No.: US 2026/0295319 A1
(43) Pub. Date: Oct. 1, 2026

(54) SPRINKLER INTERLOCK SYSTEMS AND METHODS

(71) Applicant: Tyco Fire Products LP, Cranston, RI (US)

(72) Inventors: Ian M. Jutras, Sharon, MA (US); Ivan Rhodehamel, North Providence, RI (US)

(73) Assignee: Tyco Fire Products LP, Cranston, RI (US)

(21) Appl. No.: 19/574,879

(22) Filed: Mar. 23, 2026

Related U.S. Application Data
(60) Provisional application No. 63/778,085, filed on Mar. 26, 2025.

(51) Int. Cl. A62C 37/40; A62C 3/00

(52) U.S. Cl. CPC A62C 37/40; A62C 3/002

(57) ABSTRACT

A fire protection system can include a plurality of sprinklers arranged relative to rack storage, a first detector, a second detector, and a controller. The first detector at a first position relative to the plurality of sprinklers. The second detector is at a second position different from the first position. The controller is to actuate a valve to provide water to the plurality of sprinklers based at least on any two or more of an actuation of one or more sprinklers, a first detection of fire by the first detector, and a second detection of fire by the second detector.

### CROSS-REFERENCE TO RELATED APPLICATIONS

The present application claims the benefit of and priority to U.S. Provisional Application No. 63/778,085, filed Mar. 26, 2025, the disclosure of which is incorporated herein by reference in its entirety.

### BACKGROUND

Fire protection systems can include sprinklers that output fluid in response to a fire condition. The sprinklers can be arranged in various locations relative to a building or structure, such as to address fires in proximity to stored commodities.

### SUMMARY

At least one aspect relates to a fire protection system. The fire protection system can include a plurality of sprinklers arranged relative to a rack that is to store a stored commodity. The fire protection system can include a first detector at a first position relative to the plurality of sprinklers. The fire protection system can include a second detector at a second position different from the first position. The fire protection system can include a controller to actuate a valve, to provide water to the plurality of sprinklers, based at least on any two or more of: an actuation of one or more sprinklers of the plurality of sprinklers; a first detection of fire by the first detector; and a second detection of fire by the second detector.

At least one aspect relates to a system. The system can include a plurality of first detectors. The system can include a plurality of second detectors. The system can include a controller to transmit an activation signal to a valve, the valve coupled with a plurality of sprinklers arranged to provide fire protection to a rack storage. The controller is to transmit the activation signal based at least on a first detection signal from at least one first detector and a second detection signal from at least one second detector.

At least one aspect relates to a method. The method can include detecting at least two of an actuation of one or more sprinklers of the plurality of sprinklers, a first detection of fire by the first detector, and a second detection of fire by the second detector. The method can include actuating a valve, to provide water to the plurality of sprinklers, based at least on detecting the at least two of the actuation, the first detection, and the second detection.

### BRIEF DESCRIPTION OF THE DRAWINGS

FIG. 1 is a block diagram of an example of a fire protection system.

FIG. 2 is a schematic diagram of an example of a fire protection system that can be used for rack storage.

FIG. 3 is a schematic diagram of an example of a fire protection system that can be used for rack storage.

FIG. 4 is an elevation view of an example of rack storage.

FIG. 5 is a flow diagram of a method of interlocked sprinkler operation.

### DETAILED DESCRIPTION

Following below are more detailed descriptions of various concepts related to, and implementations of systems that include sprinklers that can be deployed for fire protection of stored commodities, such as sprinkler interlock systems. The various concepts introduced above and discussed in greater detail below can be implemented in any of numerous ways, including in dry systems, preaction systems, and wet systems, and including in mechanically, pneumatically, hydraulically, and/or electronically operated systems, such as to selectively control fluid output by sprinklers responsive to detection of a fire condition (e.g., responsive to pressure changes resulting from sprinklers opening to allow air or fluids in the system to be outputted; responsive to electronic actuation of one or more actuators or valves based on detecting the fire condition using temperature, heat, gas, smoke, or other sensors).

Fire protection systems and/or sprinkler systems can include sprinklers that are provided in structures such as buildings and/or warehouses. The buildings can have stored commodities to be protected from fires. The sprinklers can be arranged to address a fire in proximity to and/or of the stored commodities, such as to output fluid (e.g., water) to address the fire.

The fire protection system can include ceiling sprinklers. The ceiling sprinklers can be coupled with piping that is mounted on or near a ceiling of the building. The ceiling sprinklers can be positioned to be above the stored commodity. The ceiling sprinklers can be positioned so that the deflectors of the ceiling sprinklers are at least a target distance and/or range of distances below the ceiling and/or above the stored commodity.

Some fire protection systems, including those that have ceiling sprinklers, may also include in-rack sprinklers. The in-rack sprinklers can be coupled with, e.g., mounted to one or more racks that are used to store the stored commodities. For example, in-rack sprinklers can be coupled with piping that is mounted on or near the one or more racks, such as within a longitudinal flue. The in-rack sprinklers can be positioned to be below at least one level of the stored commodity. The in-rack sprinklers can be positioned to be within a target distance and/or range of distances from the stored commodity.

Rack storage, including high-piled storage, can be susceptible to fires that are challenging to address. Such storage hazards can be increased for storage expected to be maintained at freezing and/or below freezing temperatures, such as in freezers. Freezer spaces make it difficult to install a wet sprinkler system, such as where water is always within the pipe network. Water within the pipes can freeze, which can cause damage to the pipes and can prevent the system from operating properly in the event of a fire. Inadvertent or accidental sprinkler activation of sprinklers in freezer spaces can be highly disruptive and challenging to clean.

Sprinkler systems within freezer spaces typically utilize a dry or preaction sprinkler system, where water is not initially within the pipe network. In such systems, an interlock and/or double interlock action is used to control the triggering of flow of water into the pipes, such as a sprinkler activating and/or separate detector providing an indication of fire detection. These systems can reduce the risk of damage from accidental release of water into the space (e.g., caused by mechanical damage or non-fire related events resulting from accidental release of water or pipe freezing, for example).

In cold storage application, techniques used to manage water flow, such as interlocks, can have additional risks, because water introduced into the piping in a non-fire event can freeze, and ice buildup can occur within the freezer spaces. This can require the space to be thawed in order to remove the ice buildup. In addition, such systems and/or dry systems, more generally, can have reduced fire suppression effectiveness (e.g., due to timing delay for water to be provided to the sprinklers) and can require a higher water demand and/or larger number of sprinkler activations associated with addressing a fire condition.

Preaction systems can include non-interlock systems, which can release water into the sprinkler pipe responsive to sprinkler activation or (triggering by) detection of a fire by one or more detectors; single interlock system, which can release water into the sprinkler pipe based on triggering by the one or more detectors; and double-interlock systems, which can release water based on triggering by both detection devices and sprinkler activation.

Although interlock systems can prevent the accidental release of water, water must physically travel from the valve to the sprinkler. This water delivery delay can have a significant effect on the suppression capability of the system. The size of a fire may be significantly larger at the end of the water delivery delay compared to a wet sprinkler system. Some fire protection systems handle the larger fire size through a surround and drown technique in which many sprinklers are expected to open before water even reaches the sprinklers. Many of these sprinklers may be far from the fire, and thus may provide little or no benefit to the suppression capabilities of the systems. Some systems attempt to minimize the number of sprinkler operations by using high temperature standard response sprinklers.

However, such approaches may not optimize useful characteristics such as the maximum number of sprinklers that activate at the end of the water delivery delay, or increasing the maximum allowable water delivery delay at which the system is still capable of controlling a fire. Reducing the number of sprinklers can reduce the maximum flow rate of the sprinkler system, which has potential to decrease the resource usage of the overall system. Increasing the maximum water delivery time can increase the flexibility when designing the sprinkler systems. Additional operational value can be gained if the minimum aisle width between storage racks is reduced and the maximum height of storage is increased. Reducing the aisle width and increasing storage height allows more commodity to be stored in the same footprint. Surround and drown techniques may not sufficiently achieve such performance criteria.

Systems and methods in accordance with the present disclosure can provide a multiple interlock solution that can allow for water delivery to occur at smaller fire sizes while maintaining or improving the maximum water delivery delay, reduced maximum number of sprinklers activated at the end of water delivery, reduced aisle width, and/or increased storage height, such as without significant negative impacts on total system flow rates and/or water delivery delay.

For example, a system in accordance with the present disclosure can trigger fire protection operation based on two (or more) of at least three events: actuation of a sprinkler (e.g., automatic sprinkler actuation); activation of a first detection system; and activation of a second detection system distinct from the first detection system. The automatic sprinkler activation can cause the gas in the sprinkler piping to be released, which can trigger a low pressure signal in the system. The other two events can be activations of either two independent detection systems or two separate detection devices that can be addressable, e.g., can have unique identifier information that can be used to individually communicate with respective detection devices, such as to associate a signal from a given detection device with a corresponding identifier and/or location. The system can include a preaction valve, which can open and allow water into the sprinkler piping, and thus to be outputted from (actuated) sprinklers, in response to any of the following cases of events: detection by the first detection system and automatic sprinkler actuation; detection by the second detection system and automatic sprinkler actuation; detection by the first detection system and the second detection system. The first and second detection systems can be detectors on separate detection circuits, such as linear heat detection (LHD) that can have lower activation temperatures and/or faster thermal responses than the sprinklers. The system can allow for various arrangements of detectors to facilitate multiple detection-based interlocks, including, for example and without limitation, where the first detection system is adjacent to the sprinklers, and the second detection system is either at the top of the rack system or at the ceiling (e.g., between midpoint of sprinklers and/or other detectors).

For example, a system (e.g., sprinkler system, fire protection system) can include a plurality of sprinklers arranged relative to a rack that is to store a stored commodity. The sprinklers can be ceiling sprinklers. The system can include a first detector at a first position relative to the plurality of sprinklers, and a second detector at a second position different from the first position. The system can include a controller to actuate a valve, to provide water to the plurality of sprinklers, based at least on any two or more of the following conditions being satisfied, such as to facilitate interlock operation with two or more conditions: an actuation of one or more sprinklers of the plurality of sprinklers; a first detection of fire by the first detector; and a second detection of fire by the second detector. This can allow the system to more rapidly deliver water to address fire conditions, including, for example, for dry and/or cold storage applications.

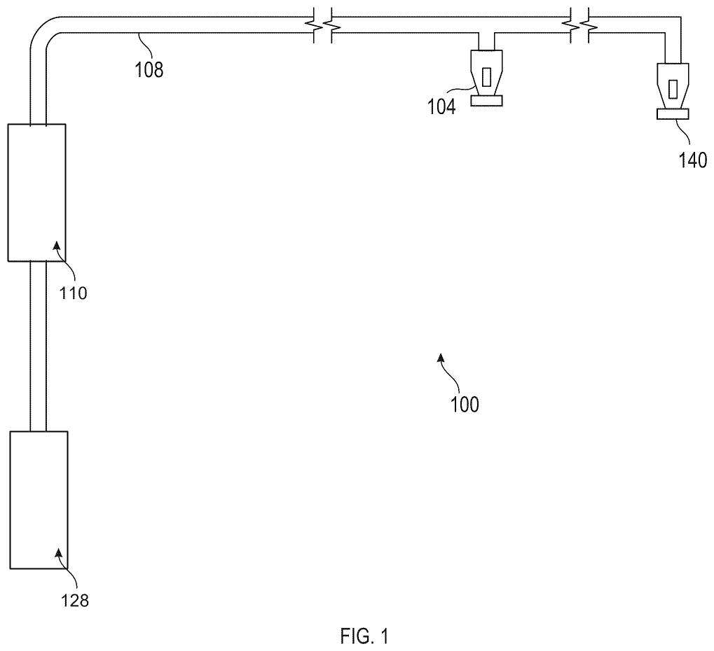

FIG. 1 depicts an example of a fire protection system 100. The fire protection system 100 can be a fire suppression system. The fire protection system 100 can be a chemical fire suppression system. The fire protection system 100 can distribute a fire suppressant agent onto or nearby a fire, extinguishing the fire and preventing the fire from spreading. The fire protection system 100 can be used alone or in combination with other types of fire suppression systems (e.g., a building sprinkler system, a handheld fire extinguisher). Multiple fire protection systems 100 can be used in combination with one another to cover a larger area (e.g., each in different rooms of a building).

The fire protection system 100 can be used in a variety of applications. The fire protection system 100 can be used with a variety of fire suppressant agents, including but not limited to water (e.g., may use powders, liquids, foams, or other fluid or flowable materials). The fire protection system 100 can be used for storage applications, including ceiling-only, in-rack, or a combination of ceiling and rack sprinklers, such as to be installed for storage commodities such as Class I, II, III or IV, Group A, Group B, or Group C plastics, elastomers, or rubber commodities, or any combination thereof. The storage commodity can be in an arrangement such as a single-row rack arrangement, a double-row rack arrangement, a multi-row rack arrangement, a palletized arrangement, a solid-piled arrangement, a bin box arrangement, a shelf arrangement, a back-to-back shelf arrangement, an on floor arrangement, a rack with solid shelves arrangement, and a rack without solid shelves arrangement, or any combination thereof.

The fire protection system 100 can include or be coupled with one or more fluid distribution devices, depicted in FIG. 1 as sprinklers 104. The fire protection system 100 can include nozzles for outputting fluid (e.g., nozzles used for deluge systems, including, for example, nozzles having open flow paths). The sprinklers 104 can include a deflector 140 that outputs fluid according to a target spray pattern corresponding to the structure of the deflector 140. The sprinklers 104 can include an activation element, such as a glass bulb or link and lever assembly, which can change from a first state that maintains the sprinkler 104 in a closed state (e.g., holds a seal against an outlet of the sprinkler 104) to a second state to allow the sprinkler 104 to open to flow fluid against the deflector 140 and towards a space around the sprinkler 104. The spray pattern of fluid from the sprinklers 104 can be outputted from the sprinklers 104 to suppress or extinguish fire within that area.

The sprinklers 104 can be used as concealed sprinklers, pendent sprinklers, upright sprinklers, water mist nozzles, or any other device for spraying fire suppressant agent. The sprinklers 104 can be early suppression, fast response (ESFR) sprinklers. The sprinklers 104 can have K-factors greater than or equal to 4.0 GPM/PSI^{(1/2)} and less than or equal to 36.0 GPM/PSI^{(1/2)} . The sprinklers 104 can have greater or lower K-factors. The sprinklers 104 can be arranged (e.g., in a grid or tree arrangement over a storage commodity) to have sprinkler to sprinkler spacings greater than or equal to eight feet by eight feet and less than or equal to twelve feet by twelve feet, greater than or equal to six feet by six feet and less than or equal to sixteen feet by sixteen feet, greater than or equal to two feet by two feet and less than or equal to twenty four feet by twenty four feet, or various combinations thereof. The spacings can be uniform or non-uniform.

The fire protection system 100 can include piping 108 connected with the sprinklers 104. The sprinklers 104 can receive water or other fire suppressant agent via the piping 108. The piping 108 can include various pipes to arrange in the sprinklers 104 in various configurations, including but not limited to tree or grid configurations. The piping 108 can include sprinkler risers. The piping 108 can include one or more pipes that extend in proximity to a stored commodity and/or one or more storage structures, such as racks.

The sprinklers 104 and/or piping 108 can be made to implement the system 100 as a dry system, such as by having gas (e.g., air and/or nitrogen) instead of water in the piping 108. This can be useful, for example, in cold storage applications, such as where the piping 108 may be exposed to temperatures at or below zero degrees Celsius.

The fire protection system 100 can include or be coupled with a fluid supply 128. The fluid supply 128 can define an internal volume filled (e.g., partially filled, completely filled) with fire suppressant agent. The fluid supply 128 can provide fluid from a remote or local location to a building in which the fire protection system 100 is located. The fluid supply 128 may include, for example, a municipal water supply, pump, piping system, tank, cylinder, or any other source of fluid or water or fire suppression agent.

The fire protection system 100 can include at least one valve 110. The valve 110 can be a flow control valve, such as to control fluid flow from the fluid supply 128 to sprinklers 104, e.g., via piping 108. The valve 110 can be a check valve, such as an alarm check valve. The valve 110 can be a clapper valve. The valve 110 can be a diaphragm valve, such as the TYCO DV-5A AUTOMATIC WATER CONTROL VALVE manufactured by Tyco Fire Products of Cranston, Rhode Island. The valve 110 can be positioned between the fluid supply 128 and the sprinklers 104 to selectively permit fluid flow from the fluid supply 128 to the sprinklers 104.

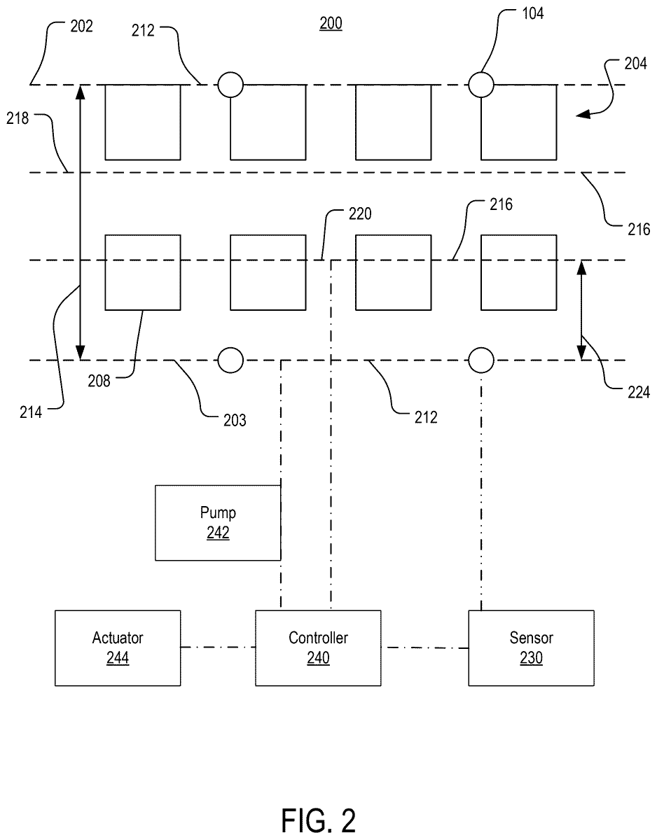

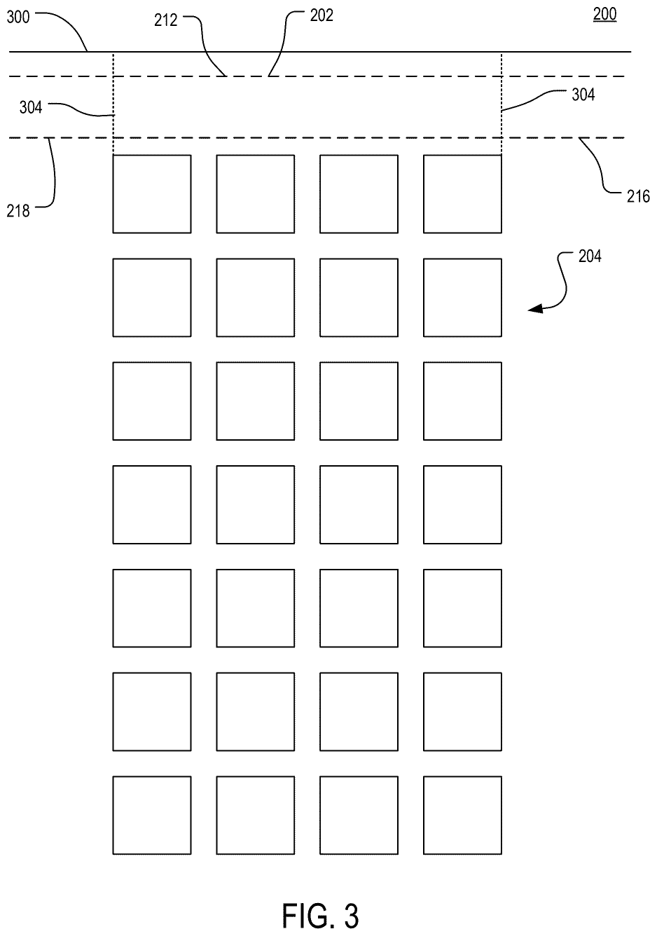

FIGS. 2-4 depict an example of a system 200. The system 200 can incorporate features of the system 100 described with reference to FIG. 1. For example, the system 200 can include a plurality of sprinklers 104, which can be provided as ceiling sprinklers coupled with the fluid supply by way of the piping 108 and valve 110 (e.g., as a clapper valve). The system 200 can include preprimed, preaction, and/or hydraulic actuation-based operation functionality. As depicted in FIGS. 2 and 3, the sprinklers 104 can be along axes 202, 203 (e.g., sprinkler axes 202, 203), which can be parallel, and can be below a ceiling 300. For example, the sprinklers 104 can include a first set of sprinklers along the axis 202 and a second set of sprinklers along the axis 203.

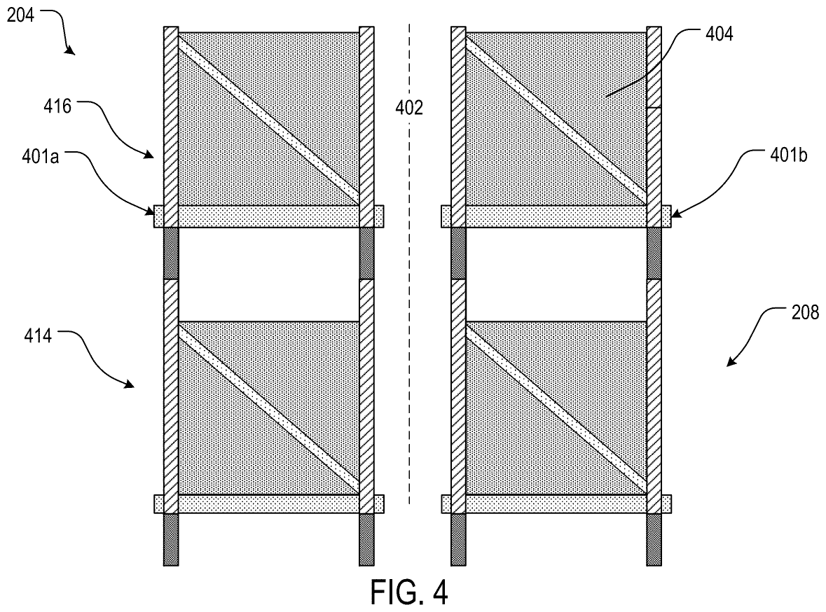

The sprinklers 104 can be arranged in relation to, such as above, rack storage 204. The rack storage 204 can include one or more rows of racks 208 (e.g., rack storage elements 208) to store a stored commodity (e.g., one or more stored commodities 404 as depicted in FIG. 4, including but not limited to pallets or boxes, for example). As noted above, the stored commodity can include any one or more Class I, II, III or IV, Group A, Group B, or Group C plastics, elastomers, or rubber commodities, or any combination thereof. The storage commodity and/or the one or more racks 208 can be in an arrangement such as a single-row rack arrangement, a double-row rack arrangement, a multi-row rack arrangement, a palletized arrangement, a solid-piled arrangement, a bin box arrangement, a shelf arrangement, a back-to-back shelf arrangement, an on floor arrangement, a rack with solid shelves arrangement, and a rack without solid shelves arrangement, or any combination thereof. The stored commodity can be stored in a building having a ceiling 300. The ceiling height can be of various heights. The ceiling height can be, for example and without limitation, 35 feet, greater than 35 feet, greater than 60 feet, or greater than 65 feet. The ceiling height can be less than 60 feet. The sprinklers 104 can be coupled with the ceiling 300, e.g., mounted to piping 108 that is coupled with and/or mounted to the ceiling 300.

The stored commodity can be stored to a height indicative of the system 200 satisfying criteria, such as fire tests, for fire protection of the stored commodity. For example, the height of the stored commodity can be greater than or equal 30 feet, 40 feet, 50 feet, 60 feet, or 65 feet. The height of the stored commodity can be less than such heights. As described herein, the system 200 can include multiple interlocks associated with operation of sprinklers 104 to allow for more effective operation of sprinklers 104, which can allow for greater heights and/or smaller aisle widths for the stored commodity, such as heights greater than 65 feet.

The sprinklers 104 can be disposed below a ceiling 300 of a building or other structure in which the racks 208 are disposed. For example, the sprinklers 104 and/or piping can be mounted to one or more structures of the building, such as the ceiling 300. The sprinklers 104 can be disposed such that the deflector 140 of the sprinklers 104 is within a target distance of the ceiling and/or the racks 208. The sprinklers 104 can be arranged at an analogous distance as for ceiling-only sprinklers.

The sprinklers 104 can be positioned in proximity to the racks 208. For example, the sprinklers 104 can be disposed within a distance and/or within a range of distances from the racks 208. One or more sprinklers 104 can be positioned in between racks 208.

The sprinklers 104 can be arranged in one or more levels (e.g., groups of sprinklers 104 at the same height). The sprinklers 104 can be at various heights, which can depend on factors including, for example, the height of the stored commodity. The sprinklers 104 can have sprinkler-to-sprinkler spacings (e.g., along length of piping 108) greater than or equal to 3 feet and less than or equal to 16 feet, such as greater than or equal to 4.5 feet and less than or equal to 9 feet, for example and without limitation.

As noted above, the sprinklers 104 can be arranged as (part of) a dry sprinkler system, such that the piping 108 can have air or nitrogen, rather than water (and in which case, water may not be outputted until the sprinklers 104 are opened and coupled with fluid from the fluid supply 128). There can be a water delivery delay associated with an amount of time from detection of a fire (e.g., by one or more detectors 212, 216; by actuation of a sprinkler 104 and/or detection of a pressure drop from actuation of a sprinkler 104) to delivery of water to the sprinkler 104 associated with detection of the fire from fluid supply 128. The sprinklers 104 can be arranged as (part of) a preprimed and/or wet sprinkler system, such that the piping 108 can have (e.g., be filled with) water. The water can be provided up to a seal of the sprinklers 104, such that the water in the piping 108 can be outputted responsive to one or more sprinklers 104 operating.

As depicted in FIGS. 2 and 3, the system 200 can include at least one first detector 212. The first detector 212 can include any one or more types of detectors, such as any one or more heat detectors, linear heat detectors, addressable detectors, smoke detectors, rate of rise heat detectors, or fixed temperature heat detectors, for example. The first detector 212 can output a detection signal (e.g., first detection signal) responsive to detecting a fire condition, such as based at least on a threshold temperature and/or a threshold amount of heat detection. The first detector 212 can have a temperature rating, e.g., a threshold temperature at which the first detector 212 detects the fire condition to output the detection signal. The temperature rating can be less than a temperature rating of the sprinklers 104, which can allow the first detector 212 to activate earlier (e.g., over a time period of development of a fire) than the sprinklers 104. The temperature rating can be, for example, 155 degrees Fahrenheit (or values higher or lower). The first detector 212 can have a thermal response (e.g., response time index) than can be faster than that of the sprinklers 104, such as to allow the first detector 212 to activate earlier than the sprinklers 104.

The first detector(s) 212 can be arranged adjacent to the sprinklers 104, such as to be within a threshold distance of the sprinklers 104 (e.g., respectively within a foot of a sprinkler 104; within six inches of a sprinkler 104; vertically aligned with the sprinklers 104; between sprinklers 104 and the ceiling 300 and/or closer to the ceiling 300 than the sprinklers 104). The first detectors 212 can be above the rack storage 204 and below the ceiling 300. As depicted in FIG. 2, some first detectors 212, such as a first row of first detectors 212, can be laterally aligned with the racks 208 (e.g., in a plane adjacent to a face of the racks 208), e.g., parallel with axis 202; some first detectors 212, such as a second row of first detectors 212, can be spaced from the first row by a distance 214, such as to be offset from faces of racks 208, e.g., parallel with axis 203. The rows of first detectors 212 can be spaced at various distances, including multiples of distance 214 (e.g., double the distance 214, with second detectors 216 at the distance 214). The rows of first detectors 212 can be spaced by distance 224, such as to also include second detectors 216 along the longitudinal flue (e.g., longitudinal flue 402 forming a space between racks 208 in FIG. 4) associated with the racks 208. The first detectors 212 can be at a same height as the sprinklers 104 and above the racks 208, or can be closer to the ceiling 300 than the sprinklers 104, for example. The first detectors 212 can be arranged in various orientations, e.g., perpendicular to the axis 202.

The system 200 can include at least one second detector 216, which can be similar to the first detectors 212. The second detector 216 can be, analogous to the first detector(s) 212, of any one or more types of detectors, such as one or more heat detectors, linear heat detectors, addressable detectors, smoke detectors, rate of rise heat detectors, or fixed temperature heat detectors, for example. The second detector 216 can output a second detection signal based on detection of a fire condition. The second detector 216 can have a temperature rating that can be less than that of the sprinklers 104 and/or a thermal response that can be faster than that of the sprinklers 104.

The second detector 216 can be at a different position than the first detector 212. For example, the second detector 216 can be arranged along an axis 218, such as to be closer to the top of the racks 208 than the first detector 212. For example, where arranged at the top of or within the racks 208, the second detectors 216 can be parallel with a longitudinal flue of the racks 208. The second detector 216 along the axis 218 can be at or within a threshold distance of a height of the top of the racks 208 (e.g., within one foot; within six inches; at any of various vertical positions in the longitudinal flue above a midpoint of the racks 208). The axis 218 can be between adjacent racks 208 (e.g., horizontally between; the axis 218 can be above tops of the racks 208). The second detectors 216 can be below the sprinklers 104.

The second detector(s) 216 can be arranged along an axis 220, such as to be proximate to and/or at the same height as axes 202, 203. The axis 220 can be arranged relative to the axes 202, 203, such as to be at a distance 224 halfway between the axes 202, 203, e.g., to be halfway between axes along which the sprinklers 104 are arranged. For example, the second detectors 216 can be between the axes 202, 203. The axis 220 can be perpendicular to the longitudinal flue. The first detectors 212 and second detectors 216 can be arranged along multiple parallel branch lines (e.g., branch lines corresponding to structure of the detectors 212, 216 and/or wiring of the detectors 212, 216), which can be aligned with the respective axes 202, 203, 220.

The arrangement of the detectors 212, 216 can allow for more effective interlock operation for the system 200. For example, as compared to systems that implement double interlocks with (1) sprinkler activation signals and (2) detector activation signals, the system 200 can allow for a two of three interlock in which multiple independent detections from the detector 212 and the detector 216 can trigger fluid delivery to the sprinklers 104, including because of the differentiation in the positioning of detectors 212, 216 relative to the racks 208. This can allow for faster fluid delivery and/or fluid to be delivered at a smaller fire size, e.g., reduced maximum delivery delay, which can allow for less water usage, higher storage heights, smaller aisle widths, and/or greater distance from the sprinklers 104 or a component thereof to the ceiling 300 (e.g. and without limitation, from 7 inches to 12 inches), which can allow for greater lengths of piping 108 and/or easier arrangement of piping 108 including where piping 108 includes sloped pipes.

The system 200 can include at least one sensor 230. The sensor 230 can detect actuation of one or more sprinklers 104, such as in response to a fire condition. For example, the sensor 230 can be coupled with piping 108 and/or one or more sprinklers 104, such as to detect a pressure drop in the piping 108 indicative of sprinkler activation. For example, the sensor 230 can include a pressure sensor. The sensor 230 can output a detection signal, e.g., pressure signal, indicative of actuation of one or more sprinklers 104. The sensor 230 can include an electronic component, such as a switch, coupled with an electronic actuator of the sprinklers 104 where the sprinklers 104 are implemented as electronic sprinklers.

The system 200 can include at least one controller 240. The controller 240 can include one or more processors and memory. The controller 240 can include any of various electronic control hardware devices, for example and without limitation, a microcontroller, an application specific integrated circuit (ASIC), or a field programmable gate array (FPGA), such as a device to have relatively low power draw during standby operation and/or upon activation by a user (e.g., firefighter). The processor may be a general purpose or specific purpose processor, an application specific integrated circuit (ASIC), one or more field programmable gate arrays (FPGAs), a group of processing components, or other suitable processing components. The processor may be configured to execute computer code or instructions stored in memory (e.g., fuzzy logic, etc.) or received from other computer readable media (e.g., CDROM, network storage, a remote server, etc.) to perform one or more of the processes described herein. The memory may include one or more data storage devices (e.g., memory units, memory devices, computer-readable storage media, etc.) configured to store data, computer code, executable instructions, or other forms of computer-readable information. The memory may include random access memory (RAM), read-only memory (ROM), hard drive storage, temporary storage, non-volatile memory, flash memory, optical memory, or any other suitable memory for storing software objects and/or computer instructions. The processor can be implemented as a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof. The memory may include database components, object code components, script components, or any other type of information structure for supporting the various activities and information structures described in the present disclosure. The memory may be communicably connected to the processor and may include computer code for executing (e.g., by the processor) one or more of the processes described herein. The memory can include various modules (e.g., circuits, engines) for completing processes described herein.

The controller 240 can be coupled with the first detector 212, and can be coupled with the second detector 216. For example, the controller 240 can receive the detection signals from the detectors 212, 216. The controller 240 can include or be coupled with a plurality of detection circuits and/or input ports, such as to independently receive signals from the detectors 212, 216 and/or from the sensor 230. For example, the controller 240 can (independently) receive signals from any one or more detectors 212, 216 and/or sensors 230.

Referring further to FIGS. 1-3, the system 200 can include at least one actuator 244. The actuator 244 can cause the valve 110 to open. The actuator 244 can include a hydraulic actuator, such as a rotary actuator. The actuator 244 can include a valve, such as a solenoid valve. The actuator 244 can be a reset actuator, such as to be used to reset pressure in the valve 110. The actuator 244 can be the TYCO MRA-1 MANUAL RESET ACTUATOR manufactured by Tyco Fire Products of Cranston, Rhode Island.

The controller 240 can control operation of the actuator 244, such as to cause the actuator 244 to operate the valve 110, such as to open the valve 110. This can allow the controller 240 to cause the valve 110 to cause fluid to flow from the fluid supply 128, through the valve 110 and piping 108, to the sprinklers 104. For example, the controller 240 can transmit a control signal to at least one of the actuator 244 and the valve 110 to operate the valve 110. The controller 240 can operate a pump 242 to provide fluid to the sprinklers 104, such as to pump fluid from the fluid supply 128 to the sprinklers 104. The controller 240 can cause an initial activation of the pump 242, such as based on one of the two or more interlocks that are used to trigger fluid delivery, such as to allow water to come to pressure prior to the valve 110 being operated. For example, the controller 240 can trigger activation of the pump 242 in response to receipt of an earlier of the first detection signal from one or more detectors 212, the second detection signal from one or more detectors 216, or a third detection signal from one or more sensors 230.

The controller 240 can cause fluid delivery to sprinklers 104, e.g., to cause the valve 110 to operate, according to a multiple interlock scheme that is triggered based at least on multiple detection signals from multiple of (1) detector(s) 212; (2) detector(s) 216; (3) sensor(s) 230, e.g., based at least on detection of automatic actuation of sprinklers 104.

For example, the controller 240 can cause the valve 110 to operate based at least on any two (or more) of: an actuation of one or more sprinklers 104; a first detection of fire by the first detector(s) 212; and a second detection of fire by the second detector(s) 216. For example, the controller 240 can cause the valve 110 to operate based at least on a first detection signal from at least one first detector 212 and a second detection signal from at least one second detector 216. The controller 240 can cause the valve 110 to operate based at least on a first detection signal from at least one first detector 212 and a sprinkler actuation signal (e.g., from sensor 230). The controller 240 can cause the valve 110 to operate based at least on a second detection signal from at least one second detector 212 and a sprinkler actuation signal (e.g., from sensor 230). The controller 240 can cause the valve 110 to operate based at least on two of such conditions without the third condition being met, e.g., according to the first and second detection signals (without the sprinkler actuation signal), or according to one of the detection signals and the sprinkler actuation signal (without the other detection signal).

As depicted in FIG. 3, the rack storage 204 can define one or more boundaries 304. The boundaries 304 can represent vertical axes and/or planes extending along the faces of the rack storage 204, such as to represent planes tangent to outer surfaces of the rack storage 204 and extending from the floor to the ceiling 300. The first detectors 212 and/or second detectors 216 can (all) be disposed within the boundaries 304, such as to be within a footprint of the rack storage 204; this can facilitate more rapid and/or accurate triggering of fluid flow to the sprinklers 104.

As depicted in FIG. 4, the rack storage 204 can include one or more rows 401a, 401b (e.g., collectively rows 401, such as rows extending into the frame of reference of FIG. 4) of racks 208, which can be used to store respective stored commodities 404. The racks 208 can form one or more levels 414, 416, for example, which can be arranged vertically from a floor towards the ceiling 300.

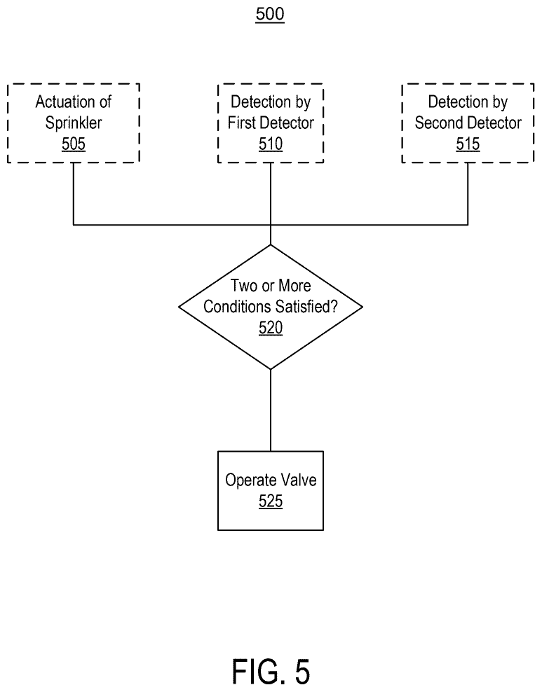

FIG. 5 depicts an example of a method 500, such as a method of operating an interlock system of a sprinkler system or fire protection system. The method 400 can be implemented by one or more components and/or systems described herein. The method 500 can be implemented for installation, setup, retrofitting, and/or testing of sprinkler systems and/or fire protection systems.

At 505, actuation of one or more sprinklers can be detected. For example, a signal can be received from a pressure sensor indicative of a pressure drop corresponding to the one or more sprinklers opening.

At 510, detection by a first detector can be detected. For example, a first detection signal from the first detector can be received. The first detector can output the first detection signal based on any one or more of heat, smoke, temperature change, or optical signals indicative of a fire condition.

At 515, detection by a second detector can be detected. For example, a second detection signal from the second detector can be received. The second detector be similar to the first detector, and can have a different position or trigger threshold from the first detector.

At 520, it can be determined whether two or more conditions of the actuation of the one or more sprinklers, the detection by the first detector, and the detection by the second detector are satisfied.

At 525, based on the two or more conditions being satisfied, fluid can be caused to flow to the one or more sprinklers. For example, a valve can be opened to allow fluid flow. A pump can be operated to cause fluid flow.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. A fire protection system, comprising:
a plurality of sprinklers arranged relative to a rack that is to store a stored commodity;
a first detector at a first position relative to the plurality of sprinklers;
a second detector at a second position different from the first position; and
a controller to actuate a valve, to provide water to the plurality of sprinklers, based at least on any two or more of:
an actuation of one or more sprinklers of the plurality of sprinklers;
a first detection of fire by the first detector; and
a second detection of fire by the second detector.

2. The fire protection system of claim 1, comprising:
a plurality of first detectors comprise the first detector, the plurality of first detectors arranged at at least a same height as the plurality of sprinklers and above the rack.

3. The fire protection system of claim 1, comprising:
the rack defines a plurality of boundaries; and
the first detector and the second detector are within the plurality of boundaries.

4. The fire protection system of claim 1, comprising:
the first detector and the second detector are below the plurality of sprinklers.

5. The fire protection system of claim 1, comprising:
the first detector and the second detector are at a level of the plurality of sprinklers or higher than the plurality of sprinklers and below a ceiling that is above the plurality of sprinklers.

6. The fire protection system of claim 1, comprising:
the second detector is at a same level as or below the plurality of sprinklers.

7. The fire protection system of claim 1, comprising:
the plurality of sprinklers comprise a set of first sprinklers along a first axis and a set of second sprinklers along a second axis; and
the second detector is between the first axis and the second axis.

8. The fire protection system of claim 1, comprising:
the first detector is arranged on a first branch line;
the second detector is arranged on a second branch line parallel with the first branch line; and
the fire protection system comprises a third detector arranged on a third branch line, the third branch line parallel with the second branch line, the third detector is of a same type of detector as the first detector.

9. The fire protection system of claim 1, comprising:
the first detector and the second detector each comprise a heat detector, a linear heat detector, a smoke detector, a rate of rise heat detector, or a fixed temperature heat detector.

10. The fire protection system of claim 1, comprising:
the first detector and the second detector each have at least one of a lower temperature of activation than the plurality of sprinklers and a faster thermal response than the plurality of sprinklers.

11. The fire protection system of claim 1, comprising:
the controller comprises a first detection circuit coupled with the first detector and a second detection circuit separate from the first detection circuit and coupled with the second detector.

12. The fire protection system of claim 1, comprising:
the plurality of sprinklers have a K-factor greater than or equal to 4.2 [GPM/PSI^{(1/2)}] and less than or equal to 36.0 [GPM/PSI^{(1/2)}].

13. The fire protection system of claim 1, comprising:
the plurality of sprinklers are coupled with piping mounted to a ceiling having a height greater than 35 feet; and
the rack is arranged to a height of at least 30 feet.

14. The fire protection system of claim 1, comprising:
the stored commodity comprises at least one of Class I, II, III or IV, Group A, Group B, or Group C plastics, elastomers, and rubber commodities.

15. The fire protection system of claim 1, comprising:
the rack is of at least one of a single-row rack arrangement, a double-row rack arrangement, a multi-row rack arrangement, a palletized arrangement, a solid-piled arrangement, a bin box arrangement, a shelf arrangement, a back-to-back shelf arrangement, an on floor arrangement, a rack with solid shelves arrangement, and a rack without solid shelves arrangement.

16. The fire protection system of claim 1, comprising:
the first detector has at least one of a temperature of activation and a thermal response to allow for earlier detection than one or more sprinklers of the plurality of sprinklers.

17. A fire protection control system, comprising:
a plurality of first detectors;
a plurality of second detectors; and
a controller to transmit an activation signal to a valve, the valve coupled with a plurality of sprinklers arranged to provide fire protection to a rack storage, the controller to transmit the activation signal based at least on reception of a first detection signal from at least one first detector and a second detection signal from at least one second detector.

18. The fire protection control system of claim 17, comprising:
the controller is to transmit the activation signal based at least on one or more of (i) the first detection signal and a signal from a pressure sensor indicative of actuation of one or more sprinklers of the plurality of sprinklers or (ii) the second detection signal and the signal from the pressure sensor indicative of actuation of the plurality of sprinklers.

19. The fire protection control system of claim 17, comprising:
the controller is coupled with a sensor coupled with the plurality of sprinklers; and
the controller is to transmit the activation signal to the valve in response to receipt of a third detection signal from the sensor indicative of opening of the plurality of sprinklers and at least one of the first detection signal or the second detection signal.

20. The fire protection control system of claim 17, comprising:
the controller is to trigger activation of a pump coupled with the valve in response to receipt of an earlier of the first detection signal or the second detection signal.
